(19) United States
(12) Patent Application Publication
(10) Pub. No.: US 2017/0291544 A1
(43) Pub. Date: Oct. 12, 2017

(54) ADAPTIVE ALERT SYSTEM FOR AUTONOMOUS VEHICLE

(71) Applicant: Toyota Motor Engineering & Manufacturing North America, Inc., Erlanger, KY (US)

(72) Inventors: Mikiya Ishihara, Plano, TX (US); Yi Li, Ann Arbor, MI (US); Kazutoshi Ebe, Novi, MI (US)

(21) Appl. No.: 15/096,394

(22) Filed: Apr. 12, 2016

(51) Int. Cl. B60Q 9/00

(52) U.S. Cl. CPC B60Q 9/00

(57) ABSTRACT

Arrangements herein relate to an adaptive-alert system for an autonomous vehicle. The system can include a communications circuit interface that can be configured to communicate with an occupant sensor and to receive from the sensor physical state information associated with the occupant. Some of the physical state information may be acquired by the sensor prior to the occupant engaging the vehicle. The system can also include a processor and a warning circuit that can be configured to generate alerts having different levels of severity. The processor can be configured to cause the warning circuit to generate the alerts in response to a detected operational hazard and receive from the communications circuit interface the physical state information associated with the occupant. The processor can also be configured to, based on the received physical state information, cause a level of severity for at least one of the alerts to be adjusted.

### FIELD

The subject matter described herein relates in general to systems for providing alerts and more particularly to systems for providing alerts to occupants of an autonomous vehicle.

### BACKGROUND

In modern vehicles, there are many systems that provide information to the occupants of such vehicles. For example, many vehicles include systems that monitor vehicle parameters, like vehicle speed, fuel level, and mileage. Recently, many vehicle manufacturers have developed plans to produce autonomous vehicles. In such a vehicle, the occupants may receive an alert about the operation of the vehicle.

### SUMMARY

As presented herein, an adaptive-alert system can modify alerts that are provided to occupants during the autonomous mode based on physical state information about the occupant. In one particular example, such physical state information may be collected prior to the occupant engaging the autonomous vehicle.

An example of an adaptive-alert system for an autonomous vehicle is presented herein. The system can include a communications circuit interface that can be configured to communicate with at least one occupant sensor and to receive from the occupant sensor physical state information associated with the occupant. At least some of the physical state information may be acquired by the occupant sensor prior to the occupant engaging the autonomous vehicle. The system can also include a processor and a warning circuit, which can be configured to generate alerts having different levels of severity. The processor can be configured to cause the warning circuit to generate the alerts in response to a detected operational hazard, receive from the communications circuit interface the physical state information associated with the occupant, and based on the received physical state information, cause a level of severity for at least one of the alerts generated by the warning circuit to be adjusted.

Another example of an adaptive-alert system is presented herein. The system can include a communications circuit interface that can be configured to receive physical state information associated with the occupant. At least some of the physical state information can include biometric data collected from the occupant during an occupant resting state prior to the occupant engaging the adaptive-alert system. The system can also include a display that can be configured to display a graphical user interface (GUI) warning element and can further have a warning circuit that can be configured to generate for the display alerts having different levels of severity. The system may also include a processor that can be configured to cause the warning circuit to generate the alerts in response to a detected operational hazard, receive from the communications circuit interface the physical state information associated with the occupant, and based on the received physical state information, cause a level of severity for at least one of the alerts generated by the warning circuit to be adjusted. Adjustment of the severity level for the alert can cause a corresponding adjustment in the appearance of the GUI warning element of the display.

An example of a method of adjusting alerts based on physical state information associated with an occupant of an autonomous vehicle is also presented herein. The method can include the step of receiving the physical state information associated with the occupant. As an example, the physical state information may at least include data collected during a time period that can precede the occupant engaging the autonomous vehicle. The method can also include the steps of setting a severity level for alerts associated with operation of the autonomous vehicle that can correspond to the received physical state information associated with the occupant and detecting an operational hazard while the occupant engages the autonomous vehicle. In response to the detection of the operational hazard, GUI warning elements may be shown on a display to warn the occupant of the operational hazard, and the displayed GUI warning elements may be based on the setting of the severity level.

### BRIEF DESCRIPTION OF THE DRAWINGS

FIG. 1 is an example of a portion of a vehicle.

FIG. 2 is an example of another portion of the vehicle of FIG. 1.

FIG. 3 is an example of a block diagram that illustrates several components of an adaptive-alert system.

FIG. 4 is an example of a method for providing adaptive alerts in an autonomous vehicle.

FIG. 5 is an example of a display that shows graphical user interface (GUI) warning elements based on a first attentiveness level.

FIG. 6 is an example of a display that shows GUI warning elements based on a second attentiveness level.

FIG. 7 is an example of a head-up display (HUD) that shows GUI warning elements based on the first attentiveness level.

FIG. 8 is an example of a HUD that shows GUI warning elements based on the second attentiveness level.

### DETAILED DESCRIPTION

An adaptive-alert system for providing warnings to occupants of an autonomous vehicle is presented herein. As an example, the system can be part of the autonomous vehicle and can include a communications circuit interface, which can be configured to communicate with at least one occupant sensor and to receive from the occupant sensor physical state information associated with the occupant. At least some of the physical state information may be acquired by the occupant sensor prior to the occupant engaging the autonomous vehicle. The system can also include a warning circuit that can be configured to generate alerts having different levels of severity. A processor may also be part of the system, and the processor can be configured to cause the warning circuit to generate the alerts in response to a detected operational hazard and to receive from the communications circuit interface the physical state information associated with the occupant. The processor can be further configured to cause a level of severity for at least one of the alerts generated by the warning circuit to be adjusted based on the received physical state information.

Accordingly, information about the well-being of an occupant may be collected prior to the occupant engaging the vehicle and can be used to set one or more alerts in a corresponding manner. For example, if the information about the user indicates that the user is possibly fatigued, the vehicle may be made aware of this information and can adjust its warnings to account for this state. Conversely, if the acquired information indicates that the occupant is well-rested or otherwise engaged, the alerts may be adjusted to reduce their number or severity, which can improve the driving experience of the occupant.

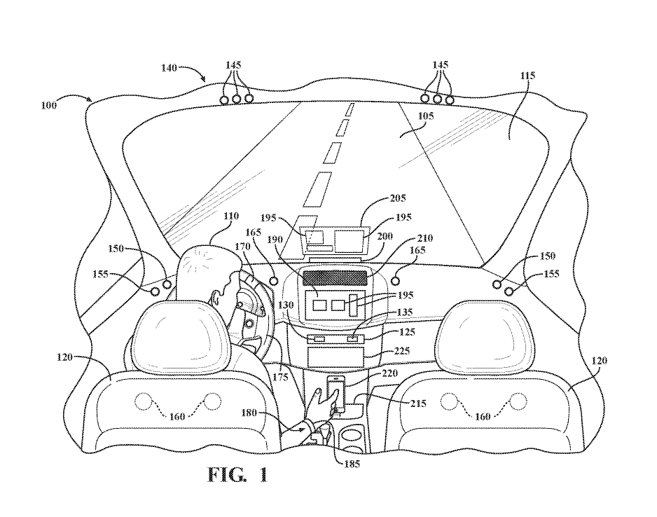

Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. Those of skill in the art, however, will understand that the embodiments described herein can be practiced without these specific details.

Several definitions that are applicable here will now be presented. The term “vehicle” is defined as a conveyance that provides transport to humans, animals, machines, cargo, or other objects. An “occupant” is defined as a person, animal, or machine that is transported or transportable by a vehicle. In view of this definition, a person, animal, or machine may be considered an occupant when inside the vehicle or outside the vehicle. A “sensor” is defined as a component or a group of components that are sensitive to one or more stimuli that are capable of being generated by or originating from a human or animal body, a composition, a machine, etc. or are otherwise sensitive to variations in one or more phenomena associated with such human or animal body, composition, machine, etc. and provide some signal or output that is proportional or related to the stimuli or the variations.

A “processor” is defined as a hardware component or group of hardware components that are configured to execute instructions or are programmed with instructions for execution (or both), and examples include single and multi-core processors and co-processors. The term “communication stack” is defined as one or more circuit components that are configured to support or otherwise facilitate the exchange of communication signals, including through wired connections, wireless connections, or both. A “communications circuit interface” is defined as a physical interface that is configured to communicatively couple to a sensor, portable computing device, or some other communications component, either through a wireless connection, a wired connection, or both. A “database” is defined as a hardware memory structure (along with supporting software or file systems, where necessary for operation) that is configured to store a collection of data that is organized for access.

An “autonomous vehicle” is defined as a vehicle that is configured to sense its environment and navigate itself with or without human interaction. An autonomous vehicle may operate in one or more modes, including fully autonomous, semi-autonomous (for example, adaptive cruise control), or manual (for example, human operator has control of the vehicle). The term “physical state information” is defined as information that is related to one or more biometric or physical measurements, qualities, traits, or characteristics of a subject. The term “operational hazard” is a hazard, danger, or risk, either currently in existence or with the potential of existing, that is involved with the operation of an autonomous vehicle. Examples of an operational hazard include objects in the path of the vehicle, changes in the course of a road on which the vehicle is traveling, malfunctions of components or systems of the vehicle, or certain operational modes of the vehicle.

A “display” is defined as an electronic device that is configured to show images or otherwise make them visible. A “speaker” is defined as an electronic device that is configured to broadcast audio signals. The term “mechanical stimulation device” is defined as an electronic device that is configured to generate outputs that are capable of being felt by a human or a machine (or both). A “braking system” is defined as a system that is configured to slow or stop a vehicle. A “graphical user interface” is defined as one or more elements shown or made visible by a display that are configured to provide information visually to a human (including text, icons, pictures, video, graphs, charts or any other symbols or multi-media) or to enable the human to interact with a machine. Other definitions may be presented throughout this document.

Referring to FIG. 1, an example of a portion of a vehicle 100 in a driving operation is shown. In this example, the vehicle 100 is an automobile, although it may be a motorcycle, an all-terrain vehicle (ATV), a snow mobile, a watercraft, an aircraft, a bicycle, a carriage, a locomotive or other rail car, a go cart, a golf cart or some other mechanized or even biological form of transport. In some cases, the vehicle 100 may be an autonomous vehicle, or a vehicle in which one or more computing systems are used to navigate and/or maneuver the vehicle 100 along a travel route with minimal or no input from a human driver. If the vehicle 100 is capable of autonomous operation, the vehicle 100 may also be configured to switch to a manual mode, or a mode in which a human driver controls most of the navigation and/or maneuvering of the vehicle along a travel route. The vehicle 100 may also operate in semi-autonomous mode in which a human operator maintains primary control of the vehicle 100 but one or more automated systems may assist the human operator.

In this case, the vehicle 100 may be traveling along a surface 105, such as a road or highway, although the surface 105 may be any surface or material that is capable of supporting and providing passage to vehicles. Examples include roads, parking lots, highways, interstates, runways, off-road areas, waterways, or railways. While the vehicle 100 is operated, the vehicle 100 may detect any number of operational hazards, and as will be explained later, may warn an occupant of the vehicle 100 of the danger. Examples of operational hazards include objects in the path of the vehicle 100 as it travels along the surface 105 or upcoming changes in the configuration of the surface 105. The operational hazards may be detected in any operational mode of the vehicle 100, including autonomous, semi-autonomous, or manual.

In this example, an occupant 110 is shown in the vehicle 100, and the occupant 110 is driving the vehicle 100, although an occupant 110 may also be a passenger for purposes of this description. The view presented here is similar to that of the occupant 110, or directed towards a front windshield 115 of the vehicle 100. As can be seen, the vehicle 100 may be equipped with one or more seats 120 that may be used to support an occupant 110 during operation of the vehicle 100.

In one arrangement, the vehicle 100 may include a command input system 125 (or system 125), which can include any suitable combination of circuitry and software to detect and process various forms of input from the occupant 110. As an example, the system 125 can include a voice recognition device 130, which can be configured to detect voice or other audio generated by the occupant 110 that is representative of a command. In many cases, the command may be a request directed to initiating an autonomous mode of operation, although the voice recognition device 130 may be configured to process numerous other commands.

As another example, the system 125 may include a gesture recognition device 135, which can include any suitable combination of circuitry and software for identifying and processing gestures from the occupant 110 (or some other occupant). For example, the gesture recognition device 135 may be able to detect and identify hand or facial gestures exhibited by the occupant 110, which can be used to, for example, start an autonomous mode of operation. In one embodiment, the gesture recognition device 135 may be fixed to some part of the vehicle 100, and the occupant 110 may direct any relevant gestures towards the device 135. As another example, at least a part of the gesture recognition device 135 may be portable, meaning the occupant 110 could manipulate the device 135 in a predetermined manner to initiate the autonomous mode, such as by moving the device 135 in a back-and-forth motion. In this example, the gesture recognition device 135 can be communicatively coupled to an interface (not shown here) of the vehicle 100, either wirelessly or through a wired connection.

The vehicle 100 may also have a location determination system (not shown here), which can include any suitable combination of circuitry and software to acquire positioning information of the vehicle 100. As an example, the location determination system may be based on a satellite positioning system, such as the U.S. Global Positioning System (GPS). The positioning information can include coordinates derived from the satellite positioning system, like GPS coordinates.

In one embodiment, the vehicle 100 may be equipped with an occupant monitoring system 140 (or system 140). In particular, the system 140 can include any number and type of sensors that can be configured to monitor one or more measurable characteristics of the occupant 110. In addition to the sensors, the system 140 may include supporting software and circuitry to receive and process data gathered by the sensors. As an example, the characteristics that are monitored may be useful for determining a physical state of the occupant 110. By acquiring information about the physical state of the occupant 110, the vehicle 100 may take any number of suitable actions that are commensurate with such data. For example, the system 140 may determine a direction of focus for the occupant 110 or a positioning of the body of the occupant 110, which may indicate a high or low level of attentiveness. In the case of a low level of attentiveness, the vehicle 100 may make adjustments to account for such level, like increasing a severity level of warnings that are provided to the occupant 110. In contrast, for a high level of attentiveness, the adjustment may be a decrease in the severity level of such warnings. As will be explained below, additional characteristics may be monitored and other corresponding adjustments may be made by the vehicle 100.

To enable the monitoring of the measurable characteristics of the occupant 110, the system 140 can include, for example, one or more eye sensors 145, one or more body sensors 150, and one or more audio sensors 155. The eye sensors 145 may be configured to track the movements or gaze of the eyes (including blinking or shutting of the eyes) of the occupant 110, while the body sensors 150 may be designed to monitor the positioning of one or more body parts of the occupant 110, such as the head or arms of the occupant 110. Further, the audio sensors 155 may be configured to detect audio that may be generated directly (or indirectly) by the occupant 110, such as speech (including loudness and direction of speech) or snoring.

Additional sensors may be part of the system 140, such as one or more pressure sensors 160 and one or more respiratory sensors 165. In particular, a pressure sensor 160 may be configured to detect changes in pressure at a certain location that may be based on the movement or repositioning of the occupant 110. As an example, the pressure sensors 160 may be embedded in any suitable part of the seats 120 of the vehicle 100, which is represented by the dashed outline of the pressure sensor 160. The respiratory sensor 165 can be configured to detect concentrations of one or more gases, which may be indicative of a direction in which the face of the occupant 110 is focused.

In another arrangement, one or more contact sensors 170 may be positioned throughout the vehicle 100, such as being integrated in a steering wheel 175 of the vehicle 100. The contact sensors 170 may be situated in sections of the steering wheel 175 that typically receive the hands of the occupant 110 when the occupant 110 operates the vehicle 100. As an example, the contact sensors 170 may detect the hands of the occupant 110 gripping the steering wheel 175, which may indicate a high level of attentiveness. The contact sensors 170 may also determine the amount of force applied by the occupant 110 to the steering wheel 175 as an additional factor to be considered in ascertaining the level of attentiveness. Because the contact sensors 170 may maintain direct contact with a portion of the body of the occupant 110, the contact sensors 170 may be configured to measure other characteristics of the occupant. For example, the contact sensors 170 may be designed to determine some or all of the following characteristics of the occupant 110: temperature, heart rate, blood pressure, and skin conductance. Of course, the contact sensors 170 may be designed to measure other physical traits of the occupant 110.

For convenience, each of the sensors listed above that may be part of the occupant monitoring system 140 may be collectively referred to as “sensors” in this description. The context in which these terms are used throughout this description should apply to each of the sensors recited here, except if expressly noted. For example, if a passage indicates that a sensor may be positioned at a certain location in the vehicle 100, then this arrangement may apply to all the sensors recited in this description. Moreover, the occupant monitoring system 140 may include all or fewer of the sensors listed above, and may have other sensors not expressly recited here. Additional information on these sensors will be presented below.

In one arrangement, some of the sensors may be positioned in the vehicle 100 so that they are aimed towards the face of the occupant 110 when the occupant 110 faces the front windshield 115. As an example, at least some of the sensors may be incorporated into one or more of the following components of the vehicle 100: a dashboard, a visor, the roof or support columns, a rear- or side-view mirror, the steering wheel, or one or more seats. These examples are not meant to be exhaustive, as there are other suitable locations of a vehicle that are capable of supporting a sensor, provided such locations are useful for monitoring some characteristic of an occupant.

There are other possible devices for obtaining physical state information about an occupant 110, which may operate independently of or in conjunction with any of the sensors described above. For example, an occupant 110 may possess one or more occupant sensors 180, which may be primarily designed to capture physical state information about the occupant 110 who possesses them. In addition, an occupant sensor 180 may be configured to acquire such information about the occupant 110 while the occupant 110 is engaged with the vehicle 100, prior to the occupant engaging the vehicle 100, or both. The phrase “engaged with the vehicle” or “engaging the vehicle” is defined as a state in which an occupant maintains at least some control over the vehicle, including but not necessarily limited to manual operation of the vehicle or being positioned in the vehicle during an autonomous mode of operation.

As a more specific example, the occupant sensor 180 may be configured to obtain physical state information before the occupant 110 enters the vehicle 100, such as prior to coming within a certain range of the vehicle 100, prior to opening a door of the vehicle 100, prior to sitting (or standing) in the vehicle 100, or prior to taking any step necessary to begin operation of the vehicle 100. Examples of such steps may include but are not limited to inserting a key into the ignition of the vehicle 100, pressing a start button of the vehicle 100, grasping the steering wheel of the vehicle 100, placing a foot or other body part on a braking or gas pedal of the vehicle 100, or grasping a drive- or gear-shifter of the vehicle 100. Conversely, the occupant sensor 180 may again obtain information about the occupant once the trip or operation of the vehicle 100 is completed or temporarily interrupted, such as when the occupant 110 turns off the vehicle 100, exits the vehicle 100 (including for a temporary stop during an intended trip), or moves outside a certain distance from the vehicle 100.

One example of an occupant sensor 180 is a wearable sensor 185, which may be worn around a body part of the occupant 110 or as part of an article of clothing or other accessory worn by the occupant 110. In this case, the wearable sensor 185 may be configured to monitor one or more characteristics of the occupant 110 and to share this information with the vehicle 100. Examples of such characteristics include sleep history, cardiovascular activity, neurological activity, ophthalmic activity, auditory activity, respiratory activity, or electrodermal activity. Of course, the wearable sensor 185 can be designed to monitor and provide information about many other traits of the occupant 110. In one particular example, the wearable sensor 185 may monitor the sleep of the occupant 110 and may provide to the vehicle 100 data related to the sleep history or quality of the occupant 110. The occupant sensor 180 may also be embedded within the occupant, such as a surgically implanted device that may be able to exchange information with a machine located outside the occupant's body.

An occupant sensor 180 is not necessarily limited to being a wearable or embedded sensor 185. For example, an occupant sensor 180 may be located remote to the vehicle 100, such as being positioned in the home of the occupant 110. The remote occupant sensor 180 may monitor any suitable characteristic of the occupant 110, such as prior to the occupant 110 engaging the vehicle 110. For example, an occupant sensor 180 may be a sleep monitor that is positioned next to or part of the bed or resting place of the occupant 110. The sleep monitor may establish long-range communications with the vehicle 100 to provide to the vehicle 100 data about the sleep history or quality of the occupant 110. As will be explained below, other examples of a remotely positioned occupant sensor 180 that are useful for determining physical state information about the occupant 110 and reporting it to the vehicle 100 may be implemented.

In one arrangement, the vehicle 100 may include one or more displays 190, which may be configured to display any suitable number and type of graphical user interface (GUI) elements 195. As an example, at least some of the GUI elements 195 may be GUI warning elements, which may alert the occupant 110 to a detected operational hazard. In one case, the display 190 may be positioned in the vehicle 100 to enable the occupant 110 to see any information that is displayed. In one embodiment, the display device 190 may be part of an instrument cluster (e.g., an in-dash display), which is illustrated in FIG. 1. As another example of a display 190, the vehicle 100 can include a head-up display (HUD) 200, which can also be configured to show any suitable number and type of GUI elements 195. A HUD, as is known in the art, can project an image 205 onto, in front of, or in some other spatial relationship with the windshield 115 or some other surface to enable the occupant 110 to see the image 205 without having to look away from the windshield 115 or some other view. In this example, the HUD 200 may be configured to change the dimensions of the image 205 based on certain events, examples of which will be shown later.

In another arrangement, the vehicle 100 may include one or more speakers 210 and one or more docking interfaces 215, which can be configured to dock with a portable computing device 220, such as a smartphone, tablet, or laptop. The speaker 210 can be configured to broadcast any suitable form of audio, and in one particular case, the audio may be in the form of a warning, such as when an operational hazard is detected. Examples of such warnings include a series of beeps or speech, which can be in the language of the choice of the occupant 110. As an example, the speech may be pre-recorded human voices or computer-generated voices. The docking interface 215 can include structure for engaging and supporting the portable computing device 220 and can be configured to exchange communication signals with the device 220, such as through a hard-wired connection.

To accommodate the exchange of wireless communications signals, the vehicle 100 may also include a communications circuit interface 225. The communications circuit interface 225 can be configured to operate according to any suitable wireless standard and in any suitable frequencies. Examples of suitable protocols include Bluetooth and any of the standards of the Wi-Fi family. In one arrangement, the communications circuit interface 225 can be configured to exchange wireless signals with an occupant sensor 180, including a wearable sensor 185, and the portable computing device 220. To enable data exchange with an occupant sensor 180 that is remotely located, the vehicle 100 can be equipped with communications circuitry for wide-area wireless communications, including cellular or satellite. This wide-area communications circuitry may be part of or separate from the communications circuit interface 225.

In view of the communications circuit interface 225 and other supporting structure, the occupant sensor 180 may exchange any suitable form of data with the vehicle 100. For example, any physical state information collected and/or analyzed by the occupant sensor 180 may be provide to the vehicle 100, and the vehicle 100 can take this information into consideration when taking certain actions or setting values or other levels. Because the communications circuit interface 225 may exchange signals with the portable computing device 220, the device 220 may also serve as an occupant sensor 180. In this instance, the portable computing device 220 may monitor any number of characteristics of the occupant 110, either prior to, during, or after the occupant 110 has engaged the vehicle 100.

Although only one occupant (occupant 110) is shown in the vehicle 100 in FIG. 1, and much of the description here focuses on this individual occupant 110, the embodiments presented herein are not so limited. Specifically, any number of occupants 110 may be transported by the vehicle 100, and any one of them may be monitored and provided information about the operation of the vehicle 100. For example, a number of sensors may be placed in a rear seating area (not shown) of the vehicle 100, such as being embedded in the back of a front seat 120 of the vehicle 100. As another example, one or more displays 190 or speakers 210 may be situated in the rear seating area. In addition, any number of occupants 110 may be associated with any number of occupant sensors 180, any one of which may be configured to provide physical state information about its assigned occupant 110 to the vehicle 100.

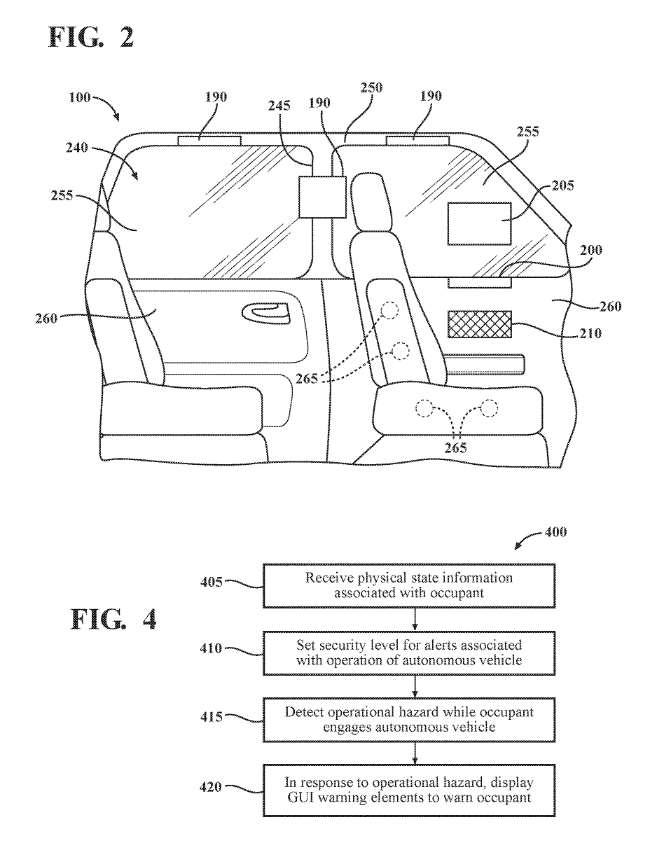

As has been previously mentioned, the vehicle 100 may warn an occupant 110 about a detected operational hazard. The vehicle 110 can be configured to provide warnings or alerts in any number of ways. For example, GUI warning elements 195 may be displayed on the display 190 or the HUD 200 or audible warnings may be broadcast through the speaker 210. Other systems or devices of the vehicle 100 may also be used to alert the occupant 100. Several examples of these systems or devices are presented in FIG. 2.

Referring to FIG. 2, another view of the vehicle 100 is shown, primarily directed to the side of a passenger compartment 240 of the vehicle 100. Here, one or more additional displays 190 or HUDs 200 may be incorporated into the passenger compartment 240 to ensure the occupant 110 (not shown here) receives the warning. As an example, other displays 190 may be integrated into support columns or pillars 245 or the roof 250 of the passenger compartment 240. As another example, other HUDs 200 may be built into the passenger compartment 240 to cause the image 205 to be projected onto, in front of, or in some other spatial relationship with a side window 255 or some other surface to enable the occupant 110 to see the image 205 without having to look away from the side window 255. Similarly, other speakers 210 may be embedded into one or more side panels 260 of the passenger compartment 240. This optional positioning of such user interface elements may be useful to provide warnings to an occupant 110 who is distracted and is facing the side of the vehicle 100 while in autonomous mode.

In another embodiment, the seats 120 of the vehicle 100 may be equipped with one or more mechanical stimulation devices 265. An example of a mechanical stimulation device 265 is a vibration unit and supporting circuitry. If a warning is to be passed to the occupant 110, the mechanical stimulation device 265 can be signaled to generate a vibration or some other stimulation, such as a sudden change in temperature, to grab the attention of the occupant 110. The examples presented here are not meant to be limiting, as the vehicle 100 may include any suitable number and type of devices that are designed to provide some stimulus to an occupant 110 to warn the occupant 110 of a detected operational hazard or some other information.

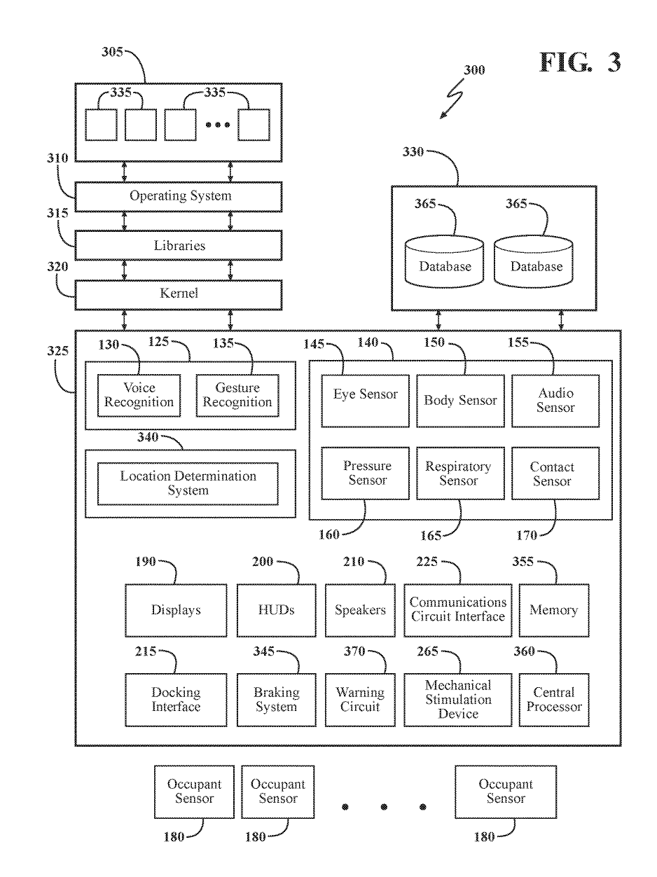

Referring to FIG. 3, an example of a block diagram of an adaptive-alert system 300 is illustrated. The adaptive-alert system 300 (or system 300) may be representative of and may include at least some of the components described in reference to FIGS. 1 and 2, although the system 300 is not necessarily limited to those components. The description associated with FIG. 3 may expand on some of the components and processes presented in the discussion of FIGS. 1 and 2, although the additional explanations here are not meant to be limiting.

In one arrangement, the adaptive-alert system 300 can include an application layer 305, an operating system (OS) 310, one or more libraries 315, a kernel 320, a hardware layer 325, and a database layer 330. The application layer 305 may include any number of applications 335, which may serve as an interface to enable an occupant 110 (not shown here) to interact with the system 300 and to execute any number of tasks or features provided by the system 300. In addition, the occupant 110 may interact and launch other processes associated with the vehicle 100 through the applications 335. For example, an occupant may launch an application 335 to enable the vehicle 100 to operate in an autonomous mode, adjust a temperature setting of the vehicle 100, or access a digital map associated with a GPS-based system. As an option, the applications 335 may be displayed on the display 190 or the image 205 from the HUD 200, and the occupant 110 may launch an application 335 by selecting it through the display 190 or the image 205. As another option, one or more of the applications 335 may be launched through a voice or gesture command.

The OS 310 may be responsible for overall management and facilitation of data exchanges and inter-process communications of the adaptive-alert system 300, as well as various other systems of the vehicle 100. The libraries 315, which may or may not be system libraries, may provide additional functionality related to the applications 335 and other components and processes of the system 300. The kernel 320 can serve as an abstraction layer for the hardware layer 325, although in some cases, a kernel may not be necessary for the system 300. Other abstraction layers may also be part of the system 300 to support and facilitate the interaction of the applications 335 with the lower levels of the system 300, although they may not be illustrated here.

The hardware layer 325 may include various circuit- or mechanical-based components to facilitate the processes that are described herein. For example, the hardware layer 325 may include the command input system 125, a location determination system 340, the occupant monitoring system 140, one or more displays 190, one or more HUDs 200, one or more speakers 210, one or more communications circuit interfaces 225, one or more memory units 355, one or more docking interfaces 215, one or more braking systems 345, one or more mechanical stimulation devices 265, one or more central processors 360, and one or more warning circuits 370. In addition, the database layer 330 may include any suitable number of databases 365 that include circuitry and are configured to store any type of data, such as in a persistent (e.g., non-volatile) manner.

As explained above, the command input system 125 can be configured to receive and identify cues from an occupant 110 or another device to initiate any suitable action. As an example, the command input system 125 can include the voice recognition device 130 and the gesture recognition device 135, although other devices may be part of the system 125. As an alternative, the system 125 is not necessarily required to include both the voice recognition device 130 and the gesture recognition device 135. In any event, the voice recognition device 130 can be configured to detect audio signals that are designed to trigger certain processes. As an example, the audio signals may be voice signals or other noises generated by an occupant 110, or, as another example, they may be sounds generated by a machine, such as one under the control of the occupant 110. In the case of audio signals generated by the machine, the audio signals may be outside the frequency range of human hearing. Reference audio signals may be digitized and stored in a database 365, and the audio signals captured by the voice recognition device 130 may be digitized and mapped against these reference signals to identify an inquiry or command.

The gesture recognition device 135 may be configured to detect and identify gestures exerted by an occupant 110. A gesture may be a form of non-verbal communication in which visible human bodily actions and/or movements are used to convey a message, although verbal communications may be used to supplement the non-verbal communication. As an example, gestures include movement of the hands, fingers, arms, face, eyes, mouth, or other parts of the body of an occupant. As an option, the gesture recognition device 135 may be designed to also detect and identify gestures produced by a machine. For example, the gesture recognition device 135 may be configured to detect and identify certain light patterns or frequencies that may serve as triggers for a command. In one embodiment, the gesture recognition device 135 may include one or more cameras (not shown) for detecting gestures. The cameras may be internal to the gesture recognition device 135, or the gesture recognition device 135 may rely on cameras that are external to it. No matter the trigger that can act as a gesture, a set of digitized reference signals may be part of one of the databases 365, and the gesture recognition device 135 may map the received gestures against this set of reference gestures.

As previously noted, a location determination system 340 can be designed to obtain positional information of the vehicle 100. In one arrangement, the location determination system 340 (system 340) can include a GPS unit (not shown) and an orientation system (not shown), although the system 340 is not necessarily required to include both the GPS unit and the orientation system and can include other devices for determining positional information. As an example, the orientation system can include accelerometers, gyroscopes, and/or other similar sensors to detect changes in the orientation of the vehicle 100.

The occupant monitoring system 140, as explained above, may include various sensors and other similar equipment for monitoring and measuring certain characteristics of an occupant 110. These devices can enable information about a physical state of the occupant to be determined. As an example, the system 140 may include any combination of the eye sensor 145, the body sensor 150, the audio sensor 155, the pressure sensor 160, the respiratory sensor 165, or the contact sensor 170. The amount and number of sensors that may be part of the system 140 is not limited to this particular listing, as other components that are capable of determining or assisting in the determination of the direction of interest for an occupant 110 may be employed here.

The eye sensor 145 can be designed to monitor the positioning, movement, or gaze of one more eyes of an occupant 110, including blinking or whether the eyes are closed. There are several techniques that may serve as solutions for the eye sensor 145. For example, the eye sensor 145 may be equipped with one or more light sources (not shown) and optical sensors (not shown), and an optical tracking method may be used. In this example, the light source may emit light in the direction of the eyes of the occupant 110, and the optical sensor may receive the light reflected off the eyes of the occupant 110. The optical sensor may then convert the reflected light into digital data, which can be analyzed to extract eye movement based on variations in the received reflections. Any part of the eyes may be the focus of the tracking, such as the cornea, the center of the pupil, the lens, or the retina. In some cases, the light source may emit an infrared light. Other solutions may be implemented to enable the eye sensor 145 to monitor the eye positioning of the occupant 110. The determination of eye positioning may be used to assign a level of attentiveness of the occupant 110.

The body sensor 150 may be configured to monitor the positioning of one or more body parts of an occupant. For example, the body sensor 150 may include one or more cameras (not shown) that can be positioned towards an occupant 110, and these cameras may capture reference images of a body part of the occupant 110, such as the head (including facial features) or shoulders. The reference images may include digital tags that are applied to certain feature points of the body part, such as the nostrils or mouth. The reference images may then be stored in one of the databases 365. When activated, the cameras of the body sensor 150 may capture one or more images of the relevant body part of the occupant 110, which may also have feature points that have been digitally tagged. The body sensor 150 can then compare in a chronological order the captured images with the reference images, such as by matching the tagged feature points and determining the distance and/or angle between the feature points. The body sensor 150 can then use this information to determine positional coordinates of the monitored body part. As an option, one or more occupant sensors 180 may be attached to or worn by the occupant 110, such as a wearable sensor 185. The occupant sensors 180 may communicate with the body sensor 150 to provide data to be used to determine the position of a body part of the occupant 110.

Other mechanisms may be used to monitor the positioning of one or more body parts of an occupant 110. For example, the body sensor 150 may include one or more acoustic generators (not shown) and acoustic transducers (not shown) in which the acoustic generators emit sound waves that reflect off the monitored body part and are captured by the acoustic transducers. The acoustic transducers may then convert the received sound waves into electrical signals that may be processed to determine the positioning of the body part. The sound waves used in this arrangement may be outside the scope of human (or animal) hearing. As another example, the body sensor 150 may include thermal imagers that may detect the positioning of the body part through analysis of thermal images of the occupant 110. In either case, the positioning of the body of the occupant 110 can be used to determine how distracted the occupant 110 is, such as during an autonomous mode of operation.

The audio sensor 155 can be configured to detect various sounds that may be attributed to the occupant 110 and can then determine a potential orientation or positioning of the occupant 110 or a level of attentiveness based on them. These sounds may be generated directly by the occupant 110, such as through speech, breathing, snoring, or coughing, although such sounds may be produced indirectly by the occupant 110. Examples of indirect sounds include the noise produced from the clothing of an occupant 110 or from a seat 120 supporting the occupant 110 when the occupant 110 moves.

In one embodiment, the audio sensor 155 can include one or more microphones (not shown) for capturing sound. A “microphone” is defined as any device, component, and/or system that can capture sound waves and can convert them into electrical signals. The microphones may be positioned throughout the vehicle 100 such that differences in the timing of the receipt of the sounds from the occupant 110 at the microphones can be detected. For example, based on the positioning of the mouth of the occupant 110, speech uttered by the occupant 110 may reach a first microphone prior to reaching a second microphone. This timing difference may serve as the basis for a directional characteristic of the occupant 110 and may be used to generate a potential positioning of the occupant 110. The magnitude of the received audio from the various microphones may also be compared to help determine the positioning of the occupant 110, which may be useful for assigning an attentiveness level to the occupant 110. For example, the receipt of a stronger signal in relation to a weaker signal may indicate the occupant 110 is closer to the microphone receiving the signal with the higher magnitude.

In one particular example, the audio sensor 155 may assign priority to speech sounds because these sounds may emanate directly from the mouth of the occupant 110 and may provide a better indication of the direction in which the occupant 110 is facing when the speech sounds are generated. The granularity of the audio sensor 155 may be increased by employing a greater number of microphones. In addition, arrays of microphones may be part of this configuration. In another example, the microphones of the audio sensor 155 may be fixed in their positions, or the locations or orientations of the microphones may be adjustable.

In one embodiment, the audio sensor 155 or some other component may also be configured to analyze sound generated by the occupant 110 to potentially determine a level of attentiveness of the occupant 110. For example, in an autonomous mode of operation, the audio sensor 155 may detect snoring sounds from the occupant 110 or may determine that the occupant 110 is involved in a voice call. As part of this analysis, detected sounds may be digitized and compared to digital reference signals that are stored in one of the databases 365. In this example, the audio sensor 155 or some other component may assign a lower level of attentiveness to the occupant 110 because the occupant 110 is asleep or is distracted by a cellular call.

The pressure sensor 160 may be configured to determine pressure values or to detect changes in pressure values that are attributable to an occupant 110, and these changes may be used to help determine the position or orientation of the occupant. For example, any number of pressure sensors 160 may be built into certain structural components of the vehicle to detect the pressure changes from the occupant 110. As a more specific example presented earlier, one or more pressure sensors 160 may be built into a seat 120 on which the occupant 110 is situated. As the occupant 110 moves to, for example, focus his or her sight on an object, the pressure sensors 160 may measure variations in the pressure generated by the body of the occupant 110. As another example, one or more pressure sensors 160 may detect subtle changes in air pressure that are caused by movement of the occupant 110. Pressure sensors 160 may also be embedded within other components of the vehicle 100 to assist in the detection of pressure variations caused by the movement of the occupant 110. Examples include the steering wheel 175, the floor of the vehicle 100, floor mats that may be positioned on the floor, or arm rests.

Based on these various pressure measurements from the different pressure sensors 160, a potential orientation of the occupant 110 can be generated, and this positioning may correspond to how distracted the occupant 110 is. In one embodiment, the occupant 110 may initially sit in a resting position, and reference pressures may be measured and stored in one of the databases 365. When the pressure measurements are received, a pressure sensor 160 may compare these measurements with the reference values to assist in the determination of the positioning of the occupant 110.

A pressure sensor 160 (or some other suitable component) may also provide the positioning of the seat 120 or a change in such positioning. For example, the pressure sensor 160 may receive input from the motors that are used to position the seat 120 according to the liking of the occupant 110. This input may also include any subsequent changes to the positioning of the seat 120.

In one arrangement, the respiratory sensor 165 can be configured to detect concentrations of one or more gases in the vehicle 100. For example, the respiratory sensor 165 can include one or more gas sensors (not shown) to detect concentrations of carbon dioxide, which may be exhaled by the occupant 110 while in the vehicle 100. The gas sensors may be situated throughout the vehicle 100 to detect the exhaled carbon dioxide from the occupants 110. In operation, if the occupant 110 turns to face an object outside the vehicle 110, meaning the occupant 110 may be distracted, the occupant 110 may be exhaling carbon dioxide in the general vicinity of one or more of the gas sensors. The gas sensors that are closest to the face of the occupant 110 may then detect increased concentrations of carbon dioxide from the breathing of the occupant 110. Based on which gas sensors are reporting the increased concentrations of carbon dioxide, the respiratory sensor 165 may determine a potential positioning or orientation of the occupant 110. Like the other sensors described above, this determination can be useful in setting or calculating a distraction or attentiveness level of the occupant 110.

As noted earlier, one or more contact sensors 170 may be positioned in the vehicle 110, such as being integrated with or placed on one or more surfaces that typically engage some body part of the occupant 110. One example is to build the contact sensors 170 into the steering wheel 175. Because a contact sensor 170 may have direct contact with the body of the occupant 110, it may monitor certain biometric characteristics of the occupant 110. For example, the contact sensor 170 may include a thermometer or some other temperature-measuring device to determine the temperature of the occupant 110. As another example, the contact sensor 170 may include a light source (not shown) and a small cuff (not shown) that can receive a finger of the occupant 110. The blood pressure of the occupant 110 may be measured when his finger is inserted into the cuff and the light source is activated. In one embodiment, the cuff and the light source may be integrated into the steering wheel 175.

A contact sensor 170 may also contain one or more electrodes (not shown) that can be used to measure electrical activity of the heart of the occupant 110, which may closely follow actual heart function. These electrodes may also be used to measure the skin conductance or other electrodermal activity of the occupant 110. The contact sensor 170 may also simply detect physical contact with the hands of the occupant 110 and, as an option, the amount of pressure from the hands.

The measurements obtained by the contact sensor 170 may serve as physical state information and can be used to determine a level of attentiveness of the occupant 110. For example, a low heart rate or blood pressure or a reduced temperature or skin conductance may be a sign of an occupant 110 who is asleep or in a relaxed state that may inhibit a quick response to a warning. Conversely, higher heart rates, blood pressures, temperatures, or skin conductances may indicate that the occupant 110 is not distracted and may respond promptly to an alert. In addition, the presence of the hands of the occupant 110 on the steering wheel and a sufficient amount of pressure from them may be a sign of an engaged occupant 110 and hence, a higher level of attentiveness.

In one arrangement, the occupant monitoring system 140 may rely on any suitable combination of sensors—including those examples described herein or others—to gather and provide data about the measured characteristics of the occupant 110. That is, the system 140 is not necessarily required to include all the sensors described above, as even a single sensor or a single set of sensors of a common type may be used here. Moreover, other sensors not illustrated here may be incorporated into the system 140.

In addition to the sensors that are part of the vehicle 100, any number of the occupant sensors 180 and the portable computing device 220 may provide physical state information to the vehicle 100. For example, if one of the occupant sensors 180 is a wearable sensor 185, the wearable sensor 185 may contain any number of electrodes for measuring cardiovascular data associated with the occupant 110, such as heart rate and blood pressure. In the case of blood pressure, the wearable sensor 185 itself may serve as a cuff if it is worn around a body part, like a wrist, and can include a light source (not shown) for enabling the measuring of blood pressure. The electrodes of the wearable sensor 185 may also be used to monitor electrodermal activity of the occupant 110, such as skin conductance. In another example, the wearable sensor 185 may be outfitted with motion-tracking circuitry and related software, which can monitor the movements of the occupant 110. This feature can enable the wearable sensor 185 to provide information related to the physical activity or the sleep history and quality of the occupant 110. In addition, the wearable sensor 185 may include more sophisticated circuitry and software for measuring sleep quality, such as tracking the sleep cycles of the occupant 110, including through the use of peripheral equipment.

In another arrangement, an occupant sensor 180 may be configured to monitor the neurological or respiratory activity of the occupant 110. For example, a wearable sensor 185 may include one or more sensors and can be configured to be worn on or around the head of the occupant 110 (or some other body part). These sensors may record electrical activity of the brain, which can be used to anticipate certain conditions, like an epileptic seizure or a narcoleptic episode. As another example, a wearable sensor 185 may include motion-tracking circuitry and related software to detect breathing motions or may be configured to support a pulse oximeter to monitor the oxygen level in the blood of the occupant 110. Measuring the oxygen level in the blood may provide an indication of low oxygen levels, meaning the occupant 110 may have breathing problems.

An occupant sensor 180 may also be configured to monitor other traits of the occupant 110, such as ophthalmic or auditory activity of the occupant 110. For example, a wearable sensor 185 may include one or more sensors that can be positioned near the eyes of the occupant 110 and can detect how often the occupant 110 blinks or shuts his eyes. An excessive amount of blinking or shutting the eyes may be a sign of fatigue or eye strain. In another embodiment, the wearable sensor 185 may include one or more sensors that measure the loudness and frequencies of sound that the occupant 110 to which the occupant 110 may be subjected. For example, the sensors may be placed near the ears of the occupant 110 or some other suitable location to detect, monitor, and record data about such sounds. If the occupant 110 experiences an inordinate amount of noise or other audio, such as over an extended period of time, the occupant 110 may not be able to sufficiently hear audio at a normal level.

Any of the occupant sensors 180 described above may provide to the vehicle 100 physical state information about the occupant 110. As an example, the occupant sensors 180 may communicate such information to the vehicle 100 through the communications circuit interface 225, whether through short- or long-range wireless or hard-wired connections. Although many of the examples above indicate the use of wearable sensors 185, at least being worn while the occupant 110 is engaged with the vehicle 100, the description here is not so limited. For example, any of the occupant sensors 180 may be positioned at the home or workplace of the occupant 110. These remote occupant sensors 180 may interact with the occupant 110 in any suitable manner, including through the use of contacts, electrodes, or sensors that may contact the body of the occupant 110. A remote occupant sensor 180, however, is not necessarily required to maintain such physical contact. For example, a remote occupant sensor 180 that measures sound levels to which the occupant 110 is subjected may be positioned at a workplace of the occupant 110, such as a construction site. The remote occupant sensors 180 may be beyond the range of the short-range wireless feature of the communications circuit interface 225, but they may still communicate with the interface 225 through long-range communications, like cellular or satellite.

In addition, any number of the occupant sensors 180 may be configured to collect physical state information about the occupant 110 while the occupant 110 is engaged with the vehicle 100, is not so engaged (i.e., prior to or before engagement), or both. The occupant sensors 180 may also communicate the collected physical state information with the vehicle 100 during any suitable time frame, including when the occupant 110 is engaged or not engaged with the vehicle 100. Moreover, the occupant sensors 180 may be configured to monitor other characteristics of the occupant 110, in addition to those presented here, or may be designed to monitor any single characteristic or any suitable combination of characteristics. No matter what type or amount of physical state information about the occupant 110 is provided to the vehicle 100, the vehicle 100 may process the information and take action accordingly. In one example, the vehicle 100 may determine, based on a collective review of the information from the various sensors, that the occupant 110 is experiencing a low level of attentiveness or is otherwise distracted. In response, the vehicle 100 may be configured to, for example, increase the severity level of warnings that are to be provided to the occupant 110, such as during an autonomous mode of operation.

Referring to some of the other components of the hardware layer 325, the display 190 may include a touch screen to enable interaction with the occupant 110. As an example, warning information may be displayed on the display 190. The display 190 may also present the applications 335, GUI elements 195, digital maps associated with the location determination system 340, and any other elements that may be used to control or manipulate systems of the vehicle 100. The HUD 200 may also be configured to display similar information, and the occupant 110 may interact with the image 205 (see FIG. 1 or 2) projected by the HUD 200. Various technologies may be used here to enable contactless interaction with the image 205, such as through the use of one or more electric fields that can indicate an interaction based on disturbances created in the fields from a finger or a tool. As will be explained below, the images shown by the display 190 or the HUD 200, such as GUI warning elements 195, may be modified based on certain events or settings.

The speakers 210 may also be used to broadcast any relevant audio, including warnings. This output may supplement the information shown by the display 190 or HUD 200, or it may be in lieu of the images being displayed. The term “speaker” is defined as one or more devices, components, or systems that produce sound, whether audible to humans or not, in response to an audio signal input. In addition to providing warnings, the speakers 210 may broadcast sounds related to other functions of the vehicle 100, such as audible directions from the location determination system 340 or music from a stereo system (not shown).

The hardware layer 325 may include any number of communications circuit interfaces 225, each of which may be configured for conducting communications in accordance with a specific frequency (or range of frequencies) and/or one or more particular communication protocols. For example, a communications circuit interface 225 may be configured to conduct satellite communications, which can be used to support the location determination system 340 or to receive data from a remote occupant sensor 180. As another example, the communications circuit interface 225 may be designed for Bluetooth, Near Field Communication (NFC) or Wi-Fi communications, relatively short-range protocols that enable wireless communications with the occupant sensors 180 or the portable computing device 220 (see FIG. 1) and other communications equipment associated with the operation of the vehicle 100. The communications circuit interface 225 may also be set up to facilitate wireless communications over a cellular network (not shown), which can enable a user to make voice calls and perform data exchanges over such wide-area networks, such as with the portable computing device 220 or a remote occupant sensor 180. An occupant 110 may also conduct wide-area network communications through the portable computing device 220 when the device 220 is docked with the docking interface 215. As an option, the docking interface 215 may be communicatively coupled with the communications circuit interface 225, either through a hard-wired or wireless connection. Other protocols and types of communications may be supported by the communications circuit interface 225, as the vehicle 100 is not limited to these particular examples described here.

The memory unit 355 can be any number of units and type of memory for storing data. As an example, the memory units 355 may store instructions and other programs to enable any of the components, devices, and systems of the adaptive-alert system 300 to perform their functions. As an example, the memory units 355 can include volatile and/or non-volatile memory. Examples of suitable data stores include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The memory units 355 can be a component of the central processor 360, or the memory units 355 can be communicatively connected to the central processor 360 (and any other suitable devices) for use thereby. These examples and principles presented here with respect to the memory units 355 may also apply to any of the databases 365 of the database layer 330.

The central processor 360 can be configured to receive input from any number of systems of the vehicle 100, including those of the adaptive-alert system 300, and can execute programs or other instructions to process the received data. The central processor 360 may request additional data from other resources and can provide output to the adaptive-alert system 300 or other systems of the vehicle 100.

For example, the central processor 360 may receive input from the command input system 125 (e.g., voice command or gesture) and can also receive positioning information from the location determination system 340. The central processor 360 may also be configured to receive input from any number of the sensors of the adaptive-alert system 300, any occupant sensors 180, and the portable computing device 220 and to analyze and process such data. As an example, this input may be physical state information associated with the occupant 110. Based on this analysis, the central processor 360 can make a determination as to a level of attentiveness of the occupant 110. Over time, the central processor 360 can continue to receive such physical state information and can update any previous determinations it has made. The central processor 360 may at least partially rely on the level of attentiveness of the occupant 110 to take some actions or enact certain settings. For example, for a lower level of attentiveness, the central processor 360 may set a higher level of severity for one or more warnings that may be generated by the adaptive-alert system 300 in response to a detected operational hazard.

In one arrangement, the central processor 360 may assign a level of attentiveness that is part of a spectrum of available choices. For example, the system 300 may include a range of attentiveness levels in which one end of the range is indicative of low or extremely low levels of engagement by the occupant, while the opposite end signals a high attentiveness level. This range may be limited to a few selections, or its granularity may be increased as desired. In either case, the level of attentiveness may be mapped to one or more corresponding actions or settings that may be taken by the vehicle 100. For example, a corresponding setting may be a severity level that is to be applied to alerts or warnings that are to be provided to the occupant 110, such as when an operational hazard is detected. That is, for a low attentiveness level, as determined by the central processor 360, the central processor 360 may select a corresponding high severity level for the warnings that are to be generated. The central processor 360 may also update these selections at any suitable time. For example, if the physical state information shows that the attentiveness level of the occupant 110 has improved, the central processor 360 may accordingly select a corresponding decreased severity level for the warnings.

The central processor 360 is not necessarily limited to using the attentiveness level to select corresponding severity levels for warnings. In particular, the central processor 360 may take other actions or choose other settings. For example, the central processor 360 may cause the speed of the vehicle 100 to be lowered in an autonomous mode of operation in response to a low attentiveness level, even though no imminent danger is detected.

The central processor 360 may receive other inputs from other components of the vehicle 100 to determine a level of severity for the warnings or for other settings. For example, the central processor 360 may receive input from the command input system 125 or from the display 190 that indicates the occupant 110 has requested an autonomous mode of operation for the vehicle 100. As another example, sensors or cameras that monitor the external environment of the vehicle 100 may indicate to the central processor 360 the presence of an operational hazard. In another embodiment, the central processor 360 may receive signals from other systems of the vehicle 100 that indicate a malfunction or inoperability of an important component, like GPS being unavailable or a sensor or camera being damaged by road debris. In either case, in view of the increased risk, the central processor 360 may increase the severity level of the warnings that are to be provided to the occupant 110. Of course, other factors may be considered in setting the severity level of the warnings, and any data received by the central processor 360 may be used to take other relevant actions. The central processor 360 may selectively rely on any of these inputs to take action, including any individual factor or any suitable combination of factors.

Any suitable architecture or design may be used for the central processor 360. For example, the central processor 360 may be implemented with one or more general-purpose and/or one or more special-purpose processors, either of which may include single-core or multi-core architectures. Examples of suitable processors include microprocessors, microcontrollers, digital signal processors (DSP), and other circuitry that can execute software. Further examples of suitable processors include, but are not limited to, a central processing unit (CPU), an array processor, a vector processor, a field-programmable gate array (FPGA), a programmable logic array (PLA), an application specific integrated circuit (ASIC), and programmable logic circuitry. The central processor 360 can include at least one hardware circuit (e.g., an integrated circuit) configured to carry out instructions contained in program code.

In arrangements in which there is a plurality of central processors 360, such processors can work independently from each other or one or more processors can work in combination with each other. In one or more arrangements, the central processor 360 can be a main processor of the adaptive-alert system 300 or the vehicle 100. This description about processors may apply to any other processor that may be part of any system or component described herein, such as the command input system 125, the location determination system 340, or the occupant monitoring system 140 and any of their associated components.

Referring to the hardware layer 325 again, the braking system 345 may include any systems, devices, circuitry, and related software that are used to stop or slow the vehicle 100, whether manually or autonomously. In an autonomous mode of operation, if the central processor 360 determines that the occupant 110 is distracted, the central processor 260 may, for example, signal the braking system 345 to selectively apply the brakes of the vehicle 100. This action may cause a rocking motion of the occupant 110, which may assist in gaining his attention. In one case, the force and periodicity of the application of the brakes may depend on the determined level of attentiveness of the occupant 110. For example, if the occupant 110 is heavily distracted or asleep, the force applied to the brakes and how often it is applied over a period of time may be increased.

The mechanical stimulation device 265 of the hardware layer 325 can be used to provide some form of stimulus to the occupant 110 to help gain the attention of the occupant 110. For example, the mechanical stimulation device 265 can include any number of vibration components and circuitry to propagate vibrations or other haptic forces through the clothing of the occupant 110 or any other suitable medium between the device 265 and the occupant 110. The level and/or frequency of vibrations can be adjusted based on, for example, the attentiveness level of the occupant 110. As another example, the mechanical stimulation device 265 can be built into one or more seats 120 (see FIG. 2) of the vehicle 100, the steering wheel 175 (see FIG. 1), or any other suitable structural element of the vehicle 100. As an option, the mechanical stimulation device 265 may include heating or cooling elements (not shown) that can adjust the temperature of the structural component housing the device 265, such as a seat 120. Adjustments in temperature may also be a way of capturing the attention of the occupant 110.

The hardware layer 325 may also include one or more warning circuits 370, which can be configured to generate alerts having different levels of severity. The warning circuit 370 may be a discrete unit in the hardware layer 325 or may be part of the central processor 360. As another example, any number of warning circuits 370 may be built into any number of devices capable of generating alerts, like the display 190, the HUD 200, the speakers 210, the mechanical stimulation device 265, or the braking system 345. If the warning circuit 370 is a discrete component or is part of the central processor 360, it may have appropriate connections to the different warning devices. In either arrangement, the central processor 360 may be configured to cause the warning circuit 370 to generate alerts in response to a detected operational hazard and to adjust selectively the level of severity for such alerts.

As noted above, many of the devices or sensors described herein map received input against reference data stored in one of the databases 365. When mapped, the device performing the comparison may determine whether the received input matches the stored reference data. The term “match” or “matches” means that the received input and some reference data are identical. To accommodate variations in the received input, however, in some embodiments, the term “match” or “matches” also means that the received input and some reference data are substantially identical, such as within a predetermined probability (e.g., at least about 85%, at least about 90%, at least about 95% or greater) or confidence level.

In some cases, the adaptive-alert system 300 may include various types and numbers of cameras. A “camera” is defined as any device, component, and/or system that can capture or record images or light. As such, a camera can include a sensor that is simply designed to detect variations in light. The images may be in color or grayscale or both, and the light may be visible or invisible to the human eye. An image capture element of the camera (if included) can be any suitable type of image capturing device or system, including, for example, an area array sensor, a Charge Coupled Device (CCD) sensor, a Complementary Metal Oxide Semiconductor (CMOS) sensor, a linear array sensor, a CCD (monochrome). In one embodiment, one or more of the cameras of the system 300 may include the ability to adjust its magnification when capturing images (i.e., zoom-in or zoom-out). As an example, these cameras may automatically adjust their magnification to better capture objects that the cameras are focused on, such as an occupant 110 making a gesture or leaning his or her body in a certain direction. Moreover, the cameras may be in fixed positions or may be pivotable to account for movement of the subject on which the cameras are focused.

Now that various examples of systems, devices, elements, and/or components of the vehicle 100 have been described, various methods or processes for adapting or adjusting alerts based on physical state information associated with an occupant 110 of an autonomous vehicle 100 will be presented. Referring to FIG. 4, a method 400 for adjusting such alerts is shown. The method 400 illustrated in FIG. 4 may be applicable to the embodiments described above in relation to FIGS. 1-3 and 5-8, but it is understood that the method 400 can be carried out with other suitable systems and arrangements. Moreover, the method 400 may include other steps that are not shown here, and in fact, the method 400 is not limited to including every step shown in FIG. 4. The steps that are illustrated here as part of the method 400 are not limited to this particular chronological order. Indeed, some of the steps may be performed in a different order than what is shown and/or at least some of the steps shown can occur simultaneously.

At step 405, physical state information associated with an occupant can be received, and a severity level for alerts associated with the operations of an autonomous vehicle can be set in which the severity level corresponds to the received physical state information, as shown at step 410. At step 415, an operational hazard can be detected while the occupant engages the autonomous vehicle. At step 420, in response to the detection of the operational hazard, GUI warning elements may be displayed on a display to warn the occupant of the operational hazard in which the GUI warning elements are based on the setting of the severity level.

For example, referring to FIGS. 1-3, any one of the sensors of the occupant monitoring system 140, the occupant sensors 180, or the portable computing device 220 may monitor any suitable characteristic of the occupant 110, including in accordance with any of the examples presented above. This monitoring can lead to a collection of physical state information of the occupant 110 and can occur when the occupant 110 is engaged with the vehicle 100 or when the occupant 110 is not so engaged. For example, information related to sleep quality, such as one or more sleep quality metrics measured during a resting state of the occupant, may be acquired prior to the occupant 110 entering the vehicle 100 for operation. Whatever information is collected, it may be provided to any suitable component of the vehicle 110, such as the central processor 360.

The central processor 360 may analyze the received information and in response, may set a severity level for alerts that are associated with operation of the vehicle 100, such as when the vehicle is in an autonomous mode. Of course, these alerts may be provided when the vehicle 100 is operated in other modes, including manual. In one arrangement, the setting of the severity level may correspond to the received physical state information. For example, if the physical state information indicates that the occupant 110 may have a low level of attentiveness, which may be as a result of a poor night of sleep, the severity level of the alerts may be set at a corresponding higher level. Thus, information about the occupant 110 may be collected prior to the occupant engaging the vehicle 100 and can be used to set a severity level for providing appropriate warnings to the occupant 110 during, for example, an autonomous mode.

Also in this example, information received from the other sensors of the occupant monitoring system 140, other occupant sensors 180, or the computing device 220 may support or confirm the low level of attentiveness exhibited by the occupant 110. For example, a wearable sensor 185 may indicate that the occupant 110 has a low heart rate and blood pressure, while a pressure sensor 160 may provide readings that show that occupant 110 has slumped into a possible sleeping position in his seat 120. The physical state information may be passed to the vehicle 100 at any suitable time, including before the occupant 110 engages the vehicle 100, prior to the initiation of an autonomous mode, or during an autonomous mode. In addition, updated physical state information can be provided to the vehicle 100 at any suitable time, at any suitable intervals, or based on detected events, like a change in the physical state of the occupant 110.

Eventually, the vehicle 100 may detect an operational hazard, such as an obstacle or a change of course in the path of the vehicle 100 during the autonomous mode. In response, the vehicle 100 may, for example, generate any suitable type of an alert (or alerts), which can be based on the setting of the severity level. For example, in the case of a high severity level, the size of GUI warning elements 195 shown by the display 190 or the HUD 200 may be increased substantially over a normal or standard configuration. Conversely, in the case of a low severity level, the size of the GUI warning elements 195 may be decreased below the breadth of the normal or standard arrangement. Other examples of warning features that may be increased or decreased (or otherwise adjusted) based on the severity level include the frequency at which the GUI warning elements 195 are flashed on the display 190 or the HUD 200, the volume of or frequency at which alert or warning sounds are broadcast through the speakers 210, or the magnitude of or frequency at which an automated braking force is applied to the braking system 345. Additional examples of warnings that may be adjusted based on the severity level include the force at which the mechanical stimulation device 265 produces its output (such as a stronger vibration, haptic force, or increased temperature change) or the onset time at which a warning is generated. In the case of the onset warning time, a low level of attentiveness, for example, may cause the onset time (the time by which the occupant 110 is to be provided the warning) to be increased. In each of these examples, a more severe form of warning can be provided to the occupant 110 if the adaptive-alert system 300 determines that the occupant 110 has a low level of attentiveness.

In addition to changing the characteristics of the warnings that are provided to the occupant 110, different devices that communicate the warnings may do so based on their positioning in the vehicle 100. For example, the body sensor 150, the audio sensor 155, the pressure sensor 160, or the respiratory sensor 165 may provide physical state information that indicates the occupant 110 is facing a side window (see FIG. 2) 255 during an autonomous mode of operation. If a warning is to be generated, the GUI warning elements 195 may be shown on a display 190 that is integrated into the side of the vehicle 100 to which the occupant 110 is facing. Similarly, warning audio may be played through the speakers 210 that are positioned on that side of the vehicle 100.

As another example, a pressure sensor 160 may determine that the seat 120 is in an inclined or substantially horizontal position, meaning that the occupant 110 may be resting. In this case, the occupant 110 may be facing the roof 250 (see FIG. 2) of the vehicle 100, and the GUI warning elements 195 may be shown on a display 190 that is integrated into the roof 250. As an option, any subsequent positional changes by the occupant 110 during an autonomous mode may cause other displays 190 (or HUDs 200), speakers 210, or other warning devices to attempt to warn the occupant 110 of a detected operational hazard.

In some cases, other events may cause a higher or adjusted severity level for warnings that are provided to the occupant 110. For example, if the vehicle 100 transitions to autonomous mode, which may be considered an operational hazard, the severity of the warnings may automatically be increased. As another example, if the vehicle 100 moves back to manual mode, the severity level of the warnings may be automatically decreased. As an option, these changes in severity level based on the operational mode may occur no matter the attentiveness level of the occupant 110. Alternatively, these changes in severity level may further impact the severity level beyond that which is already set based on the attentiveness level of the occupant 110.

In another embodiment, the type of operational hazard that is detected or the type of component that is inoperable or malfunctioning may also affect the severity level for the warnings provided to the user. For example, if an obstacle is detected in the path of the vehicle 100 or if a drastic, automated action to be carried out by the vehicle 100 is imminent, the severity level of the warnings may be automatically increased. As an alternative example, if a gradual or slight change in the course of the road on which the vehicle 100 is traveling is detected, a lower severity level may be selected for the warnings. In addition, if a certain component of the vehicle 100 is not operating properly, like a GPS receiver, the severity level of the warning may also be increased. Like the operational mode, the impact of the type of operational hazard or the type of inoperable component on the severity level may be either in addition to or in lieu of the attentiveness level of the occupant 110

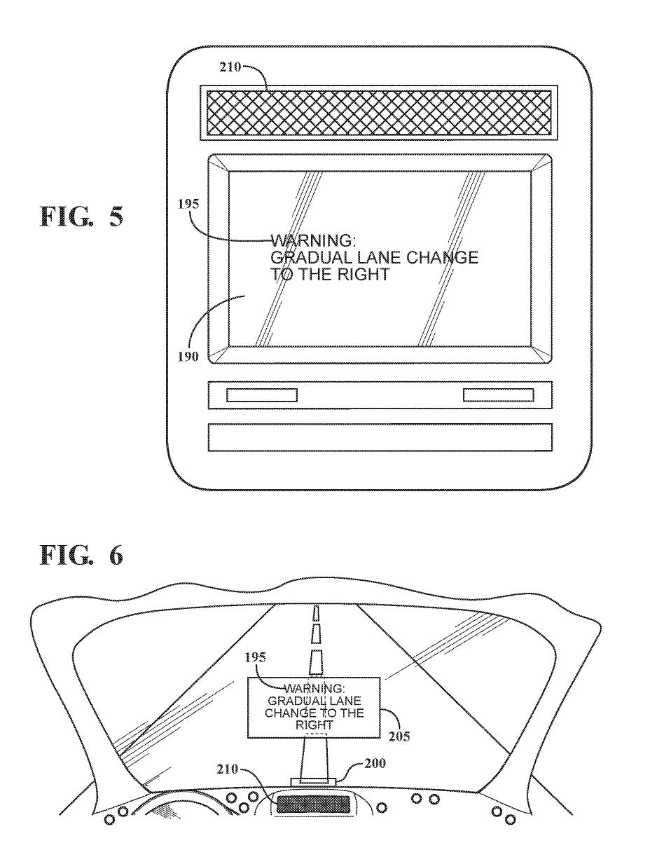

Referring to FIG. 5, a close-up view of a display 190 is shown in which the display 190 is showing GUI warning elements 195 based on a low severity level, which may be set by a high attentiveness level exhibited by the occupant 110. In this example, the warning indicates a gradual lane change for the vehicle 100 while operating in the autonomous mode. As noted earlier, other events, like a manual mode of operation or a less dangerous operational hazard, may also cause the selection of the low severity level. Here, the GUI warning elements 195 are relatively small and may remain static, such as no blinking or changes in color. In addition, the audio warnings from the speaker 210 may remain below a certain sound level and may be repeated a minimal number of times. Onset warning times may also be decreased. The mechanical stimulation device 265 and the braking system 345 may either not be activated or if activated, their impacts can be restricted or otherwise lessened. The GUI warning elements 195 may also be shown on other devices when this low severity level is detected. For example, referring to FIG. 6, an image 205 projected by a HUD 200 may be relatively limited in size, and the configurations of GUI warning elements 195 may also be reduced. In these examples, the occupant 110 may be warned of some operational hazard or other event based on the attentiveness level of the occupant 110 or some other factor.

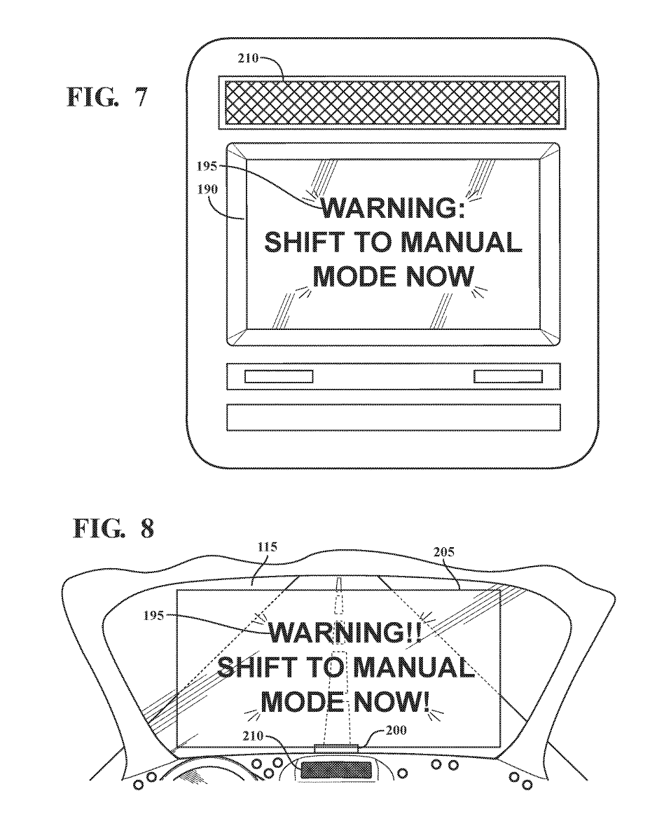

In contrast, in the event of a selection of a high severity level, more severe warnings may be generated. For example, referring to FIG. 7, the size of the GUI warning elements 195 that the display 190 is showing may be substantially increased, particularly in relation to that associated with the low severity level setting. In this example, the warning indicates a shift to manual mode must be performed. As another example, the GUI warning elements 195 may be periodically flashed (as indicated by the markings on the drawing), and the frequency at which they are flashed may be increased. In another embodiment, the color of the GUI warning elements 195 may be modified, and other displays 190 in the vehicle 100 may be activated to present the warning. In addition, the sound level of any audible warnings from the speakers 210 may be boosted, or the number of times such warnings are repeated (i.e., frequency) may be increased. Other examples include increasing the onset warning time or activating or increasing the output of the mechanical stimulation device 265. In another arrangement, the braking system 345 may be activated or the force applied to the brakes and the periodicity at which it is applied may be increased. In either scenario, the warnings that are provided may be based on a low level of attentiveness and/or some other factor.

The HUD 200 may also respond to the increased severity level. For instance, referring to FIG. 8, an example of an image 205 is shown in which the size or display surface area of the image 205 has been substantially increased, to the point that the image 205 essentially covers the entire windshield 115. In view of this adjustment, the size of the GUI warning elements 195 may also be significantly enlarged. Such images 205 may also be shown on other surfaces of the vehicle 100, such as the side windows 255, irrespective of whether the occupant 110 is facing such surfaces Like the example above, the GUI warning elements 195 of the image 205 may be flashed and their color(s) may be modified.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An adaptive alert system for an autonomous vehicle, comprising:
a communications circuit interface that is configured to communicate with at least one occupant sensor and to receive from the occupant sensor physical state information associated with the occupant, wherein at least some of the physical state information is acquired by the occupant sensor prior to the occupant engaging the autonomous vehicle;
a warning circuit that is configured to generate alerts having different levels of severity; and
a processor that is configured to:
cause the warning circuit to generate the alerts in response to a detected operational hazard;
receive from the communications circuit interface the physical state information associated with the occupant; and
based on the received physical state information, cause a level of severity for at least one of the alerts generated by the warning circuit to be adjusted.

2. The system of claim 1, wherein the warning circuit is part of a display, a speaker, a braking system, or a mechanical stimulation device.

3. The system of claim 2, wherein the processor is further configured to cause the level of severity for the alert to be generated by the warning circuit to be adjusted by causing the warning circuit to:
increase or decrease the size of graphical user interface (GUI) alert elements displayed by the display;
increase or decrease the frequency at which the GUI alert elements are flashed on the display;
increase or decrease the volume at which alert sounds are broadcast through the speaker;
increase or decrease the frequency at which alert sounds are broadcast through the speaker;
increase or decrease the magnitude of automated force applied to the braking system;
increase or decrease the frequency at which the automated force is applied to the braking system;
increase or decrease the magnitude of haptic force generated by the mechanical stimulation device; or
increase or decrease the frequency of the haptic force generated by the mechanical stimulation device.

4. The system of claim 2, wherein the display comprises multiple displays and the processor is further configured to cause the multiple displays to selectively display GUI elements based on the received physical state information associated with the occupant.

5. The system of claim 4, wherein a first display of the multiple displays is part of an instrument cluster of the autonomous vehicle, part of a side pillar of the autonomous vehicle, or part of a roof of the autonomous vehicle.

6. The system of claim 1, wherein the processor is further configured to cause the level of severity for the alert to be generated by the warning circuit to be adjusted by causing the warning circuit to increase or decrease an onset alert time.

7. The system of claim 1, wherein the processor is further configured to cause a level of severity for at least one of the alerts generated by the warning circuit to be adjusted based on the detected operational hazard.

8. The system of claim 1, wherein the operational hazard includes an operational mode of the autonomous vehicle or a level of severity of an impending automated action to be executed by the autonomous vehicle.

9. The system of claim 1, wherein the physical state information includes sleep history data of the occupant, cardiovascular data, neurological data, ophthalmic data, auditory data, respiratory data, or electrodermal activity data.

10. An adaptive-alert system, comprising:
a communications circuit interface that is configured to receive physical state information associated with the occupant, wherein at least some of the physical state information includes biometric data collected from the occupant during an occupant resting state prior to the occupant engaging the adaptive-alert system;
a display that is configured to display a graphical user interface (GUI) warning element;
a warning circuit that is configured to generate for the display alerts having different levels of severity; and
a processor that is configured to:
cause the warning circuit to generate the alerts in response to a detected operational hazard;
receive from the communications circuit interface the physical state information associated with the occupant; and
based on the received physical state information, cause a level of severity for at least one of the alerts generated by the warning circuit to be adjusted, wherein adjustment of the severity level for the alert causes a corresponding adjustment in the appearance of the GUI warning element of the display.

11. The system of claim 10, wherein the display is a head-up display (HUD) and the adjustment of the severity level of the alert is an increase of the severity level of the alert and the corresponding adjustment in the appearance of the GUI warning element is an increase in a display surface area of the HUD.

12. The system of claim 10, further comprising a speaker configured to broadcast a warning signal, wherein adjustment of the severity level of the alert also causes a corresponding adjustment in the sound of the warning signal broadcast from the speaker.

13. The system of claim 12, wherein the adjustment of the severity level of the alert is an increase of the severity level of the alert and the corresponding adjustment in the sound of the warning signal is an increase in the volume or frequency of the sound of the warning signal.

14. The system of claim 10, wherein the biometric data collected from the occupant during the occupant resting state is a sleep quality metric.

15. A method of adjusting alerts based on physical state information associated with an occupant of an autonomous vehicle, comprising:
receiving the physical state information associated with the occupant, wherein the physical state information at least includes data collected during a time period that precedes the occupant engaging the autonomous vehicle;
setting a severity level for alerts associated with operation of the autonomous vehicle that corresponds to the received physical state information associated with the occupant;
detecting an operational hazard while the occupant engages the autonomous vehicle; and
in response to the detection of the operational hazard, displaying graphical user interface (GUI) warning elements on a display to warn the occupant of the operational hazard, wherein the displayed GUI warning elements are based on the setting of the severity level.

16. The method of claim 15, wherein the display device is a head-up display (HUD) or an in-dash display device and wherein displaying GUI warning elements comprises increasing the size of the GUI warning elements, increasing the frequency at which the GUI warning elements are displayed, or changing the color of the GUI warning elements.

17. The method of claim 16, wherein increasing the size of the GUI warning elements comprises increasing a displayed surface area of the GUI warning elements as displayed by the HUD.

18. The method of claim 15, wherein receiving the physical state information associated with the occupant comprises receiving the physical state information associated with the occupant from an occupant sensor.

19. The method of claim 18, wherein the occupant sensor is a wearable sensor configured to be worn by the occupant and the physical state information at least includes sleep quality metrics that are collected by the wearable sensor.

20. The method of claim 15, wherein setting the severity level for alerts associated with operation of the autonomous vehicle that corresponds to the received physical state information associated with the occupant comprises setting an onset warning time that corresponds to the received physical state information.
